(19) United States
(12) Patent Application Publication
(10) Pub. No.: US 2023/0198103 A1
(43) Pub. Date: Jun. 22, 2023

(54) MANUFACTURING METHOD OF BATTERY PACK

(71) Applicants: TOYOTA JIDOSHA KABUSHIKI KAISHA, Toyota-shi Aichi-ken (JP); Prime Planet Energy & Solutions, Inc., Chuo-ku Tokyo (JP)

(72) Inventors: Shintaro MIYATA, Nisshin-shi Aichi-ken (JP); Nobuyuki YAMAZAKI, Okazaki-shi Aichi-ken (JP); Tomo FUKAMI, Nagoya-shi Aichi-ken (JP); Yoshinori SHIBATA, Nagoya-shi Aichi-ken (JP); Yuki OHIRA, Nisshin-shi Aichi-ken (JP); Taketoshi YOSHIKANE, Kasai-shi Hyogo-ken (JP)

(73) Assignees: TOYOTA JIDOSHA KABUSHIKI KAISHA, Toyota-shi Aichi-ken (JP); Prime Planet Energy & Solutions, Inc., Chuo-ku Tokyo (JP)

(21) Appl. No.: 17/981,642

(22) Filed: Nov. 7, 2022

(30) Foreign Application Priority Data
Dec. 20, 2021 (JP) 2021-206325

(51) Int. Cl. H01M 50/516; B23K 26/21

(52) U.S. Cl. CPC H01M 50/516; B23K 26/21; B23K 2101/36

(57) ABSTRACT

Disclosed is a manufacturing method of a battery pack in which multiple battery cells are stacked, and electrodes of adjacent battery cells of the battery cells are connected by a bus bar, the bus bar having two holes that are smaller than the electrodes, and the bus bar being disposed such that the holes overlap the electrodes respectively. The manufacturing method includes welding the bus bar and one of the electrodes, then welding the bus bar and another one of the electrodes in an intermediate region between the two holes of the bus bar, and subsequently welding the bus bar and the other one of the electrodes in an end region adjacent to the intermediate region of the bus bar.

### CROSS-REFERENCE TO RELATED APPLICATION

This application claims priority to Japanese Patent Application No. 2021-206325 filed on Dec. 20, 2021, incorporated herein by reference in its entirety.

### BACKGROUND

### 1. Technical Field

The technology disclosed in the present specification relates to a manufacturing method of a battery pack. A battery pack is a device in which multiple battery cells are stacked, and electrodes of adjacent battery cells are connected by a bus bar.

### 2. Description of Related Art

An example of a battery pack is disclosed in WO 2017/130705. The battery pack is a device in which multiple battery cells are stacked. In the battery pack, electrodes of adjacent battery cells are connected by bus bars. The battery cells are electrically connected in series or in parallel by bus bars. In the battery pack in WO 2017/130705, the bus bars and the electrodes are welded by laser. The term “bus bar” means a member made of an electroconductive metal piece, which has low internal resistance and is suitable for electric power transmission.

### SUMMARY

When welding strength between the bus bar and the electrodes is low, the bus bar is readily detached from an electrode. Attempts to increase the welding strength may place great stress on the bus bar during welding. Alternatively, attempts to increase the strength of the weld may cause the heat of the weld to damage the battery cell. The present specification provides technology for properly welding bus bars and electrodes.

A manufacturing method of a battery pack according to a first aspect disclosed in the present specification is a manufacturing method of a battery pack in which multiple battery cells are stacked, and electrodes of adj acent battery cells of the battery cells are connected by a bus bar, the bus bar having two holes that are smaller than the electrodes, and the bus bar being disposed such that the holes overlap the electrodes respectively. The manufacturing method includes welding the bus bar and one of the electrodes, then welding the bus bar and another one of the electrodes in an intermediate region between the two holes of the bus bar, and subsequently welding the bus bar and the other one of the electrodes in an end region adjacent to the intermediate region of the bus bar.

If the bus bar and the electrodes are welded in the end regions and then the bus bar and the electrode are welded in the intermediate region, a high level of stress will be generated in the intermediate region of the bus bar. This is due to, in a state in which the two points (a weld site between the bus bar and one electrode and a weld site between the bus bar and the other electrode in the end region) are constrained, the bus bar and the electrodes being welded in the region between the two constrained points (i.e., the intermediate region). Further performing welding between the two constrained points leaves no room for deformation in the bus bar, and a high level of stress is generated inside the bus bar.

By first constraining two other points (a weld site with one electrode and a weld site between the bus bar and the other electrode in the intermediate region), and thereafter welding the bus bar and the other electrode on the outer side (i.e., the end region) of the two constrained points, there is room for the bus bar to deform during the final welding, and accordingly less stress is generated in the bus bar.

The manufacturing method disclosed in the present specification may have the following features. The bus bar may have two holes that are smaller than the electrodes, and may be disposed such that the holes overlap the electrodes, respectively.

In the manufacturing method according to the above aspect, the bus bar may be irradiated by laser at a position away from an edge of one of the holes, and irradiation by the laser may be stopped when the bus bar melts up to the edge.

In the manufacturing method according to the above aspect, in welding of the intermediate region, the bus bar may be irradiated by laser at a position away from an edge of one of the holes, and irradiation by the laser may be stopped when the bus bar melts up to the edge.

A manufacturing method of a battery pack according to a second aspect of the disclosure is a manufacturing method of a battery pack in which multiple battery cells are stacked, and electrodes of adjacent battery cells of the battery cells are connected by a bus bar, the bus bar having two holes smaller than the electrodes, and the bus bar being disposed such that the holes overlap the electrodes respectively. The manufacturing method includes irradiating the bus bar by laser at a position away from an edge of one of the holes, and stopping irradiation by the laser when the bus bar melts up to the edge.

When the laser is simply applied to a position away from the edge of the hole, the electrode and the weld piece are not welded up to the edge of the hole, and high welding strength is not obtained. Directly irradiating the edge of the bus bar by laser results in a large amount of heat being transferred to the electrode, which may damage the battery cell. By irradiating the bus bar by laser at a position away from the edge of the hole and stopping the laser irradiation when the bus bar melts up to the edge, the edge of the bus bar and the electrode can be welded without damaging the battery cell. High welding strength can be obtained by welding to the electrode up to the edge of the bus bar. Note that at this time, the bus bar and the electrode are in a so-called fillet weld state. Effects can be obtained even by fillet welding alone.

Details and further improvements of the technology disclosed in the present specification will be described in the “DETAILED DESCRIPTION OF EMBODIMENTS” section below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a battery pack;

FIG. 2 is a side view of the battery pack;

FIG. 3 is a perspective view of the battery pack;

FIG. 4 is an enlarged plan view of a vicinity of a bus bar;

FIG. 5 is a sectional view taken along a dashed line V in FIG. 4;

FIG. 6 is an enlarged plan view of a vicinity of a bus bar;

FIG. 7A is a sectional view (1) taken along line VII-VII in FIG. 6;

FIG. 7B is a sectional view (2) taken along line VII-VII in FIG. 6; and

FIG. 7C is a sectional view (3) taken along line VII-VII in FIG. 6.

### DETAILED DESCRIPTION OF EMBODIMENTS

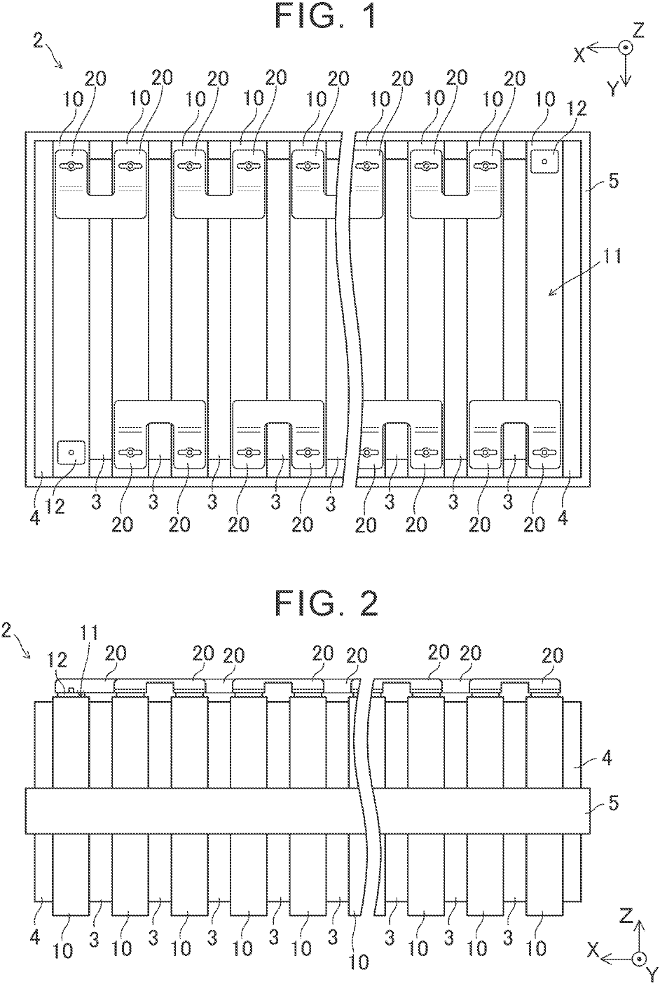

A battery pack 2 will be described prior to description of a manufacturing method according to the embodiments. FIG. 1 is a plan view of the battery pack 2, and FIG. 2 is a side view of the battery pack 2.

The battery pack 2 is a power source in which multiple battery cells 10 are stacked. The battery cells 10 have flat forms, and are arrayed with the broad faces of adjacent battery cells 10 facing each other. A spacer 3 is disposed between adjacent battery cells 10. Multiple spacers 3 and multiple battery cells 10 are provided, with the battery cells 10 and the spacers 3 being alternately stacked. One end plate 4 is disposed at either end of the stack of the battery cells 10 and the spacers 3. The spacers 3 and the end plates 4 protect the battery cells 10. The stack of the battery cells 10, the spacers 3, and the end plates 4, is banded together by a frame 5.

Two electrodes 12 are disposed on one narrow face of each battery cell 10. The face on which the electrodes 12 are provided will be referred to as “upper face 11”, for the sake of convenience of description. The two electrodes 12 are provided at both ends of the upper face 11 (one electrode 12 at one end) as viewed from a stacking direction. Note that an X direction in the coordinate system in the drawings corresponds to the stacking direction.

The electrodes 12 of adjacent battery cells 10 are connected by bus bars 20. A positive electrode 12 of one battery cell 10 and a negative electrode 12 of another battery cell 10 are connected by a bus bar 20. The positive electrode 12 of the other battery cell 10 and the negative electrode 12 of yet another battery cell 10 are connected by another bus bar 20. The battery cells 10 are all connected in series by a plurality of the bus bars 20.

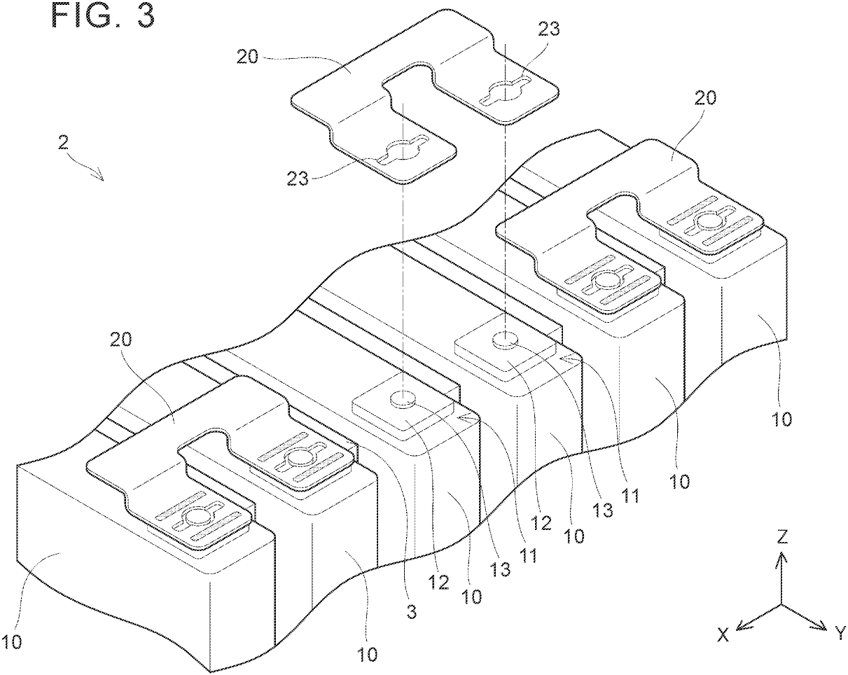

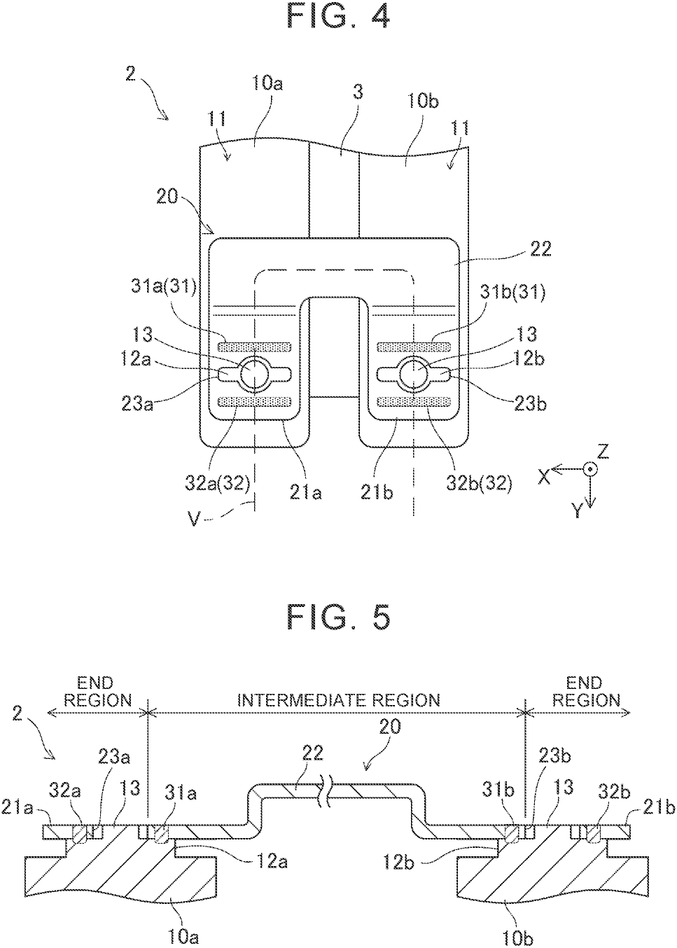

FIG. 3 is a perspective view of the battery pack 2. FIG. 3 is a partially enlarged view of the vicinity of several bus bars 20. Also, in FIG. 3, the bus bar 20 at the middle is illustrated as being away from the electrode 12, for the sake of convenience of description. FIG. 4 is an enlarged plan view of the vicinity of the bus bar 20. In FIGS. 3 and 4, regions indicated by gray hatching indicate locations where the bus bar 20 and the electrode 12 are welded, which are positions where the bus bar and the electrode temporarily fuse under the heat of welding. Hereinafter, for the sake of convenience, the regions indicated by gray hatching will be referred to as “fused sites”.

As described above, each battery cell 10 is provided with electrodes 12 on the upper face 11 thereof. The electrodes 12 are protrusions protruding from the upper face 11, and top faces thereof are flat. A small protrusion 13 is further provided on the top face of each electrode 12.

The bus bar 20 is a metal plate having a letter-U shape. For the sake of convenience of description, the bus bar 20 is divided into a pair of end portions 21a and 21b extending in parallel, and a connecting portion 22 connecting the end portions 21a and 21b. Also, for the sake of convenience of description, two adjacent battery cells 10 in FIG. 4 may be denoted as battery cells 10a and 10b, each of the electrodes 12 of the battery cell 10a as electrode 12a, and each of the electrodes 12 of the battery cell 10b as electrode 12b. The end portion 21a of the bus bar 20 is welded to the electrode 12a, and the end portion 21b is welded to the electrode 12b. When referred to without distinction, the battery cells 10a and 10b will be referred to as battery cells 10. Similarly, when referred to without distinction, the end portions 21a and 21b (electrodes 12a and 12b) will be referred to as end portions 21 (electrodes 12).

### First Embodiment

A manufacturing method of the battery pack 2 according to a first embodiment will be described. In particular, a process of welding the bus bar 20 to the electrodes 12a and 12b of the adjacent battery cells 10a and 10b will be described.

The end portion 21a is provided with a hole 23a, and the end portion 21b is provided with a hole 23b. When referred to without distinction, the holes 23a and 23b may be referred to as holes 23. The holes 23 are enlarged at middle portions. The size of each of the holes 23 is smaller than the area of the top face of the corresponding electrode 12 when viewed in plan view. Also, the middle portion of each of the holes 23 is larger than the area of the top face of the corresponding small protrusion 13 when viewed in plan view. The bus bar 20 is placed on the adjacent electrodes 12 so that the holes 23 overlap the respective electrodes 12 and the small protrusions 13 are located in the middle of the respective holes 23. Thereafter, the end portion 21a and the electrode 12a are welded, and the end portion 21b and the electrode 12b are welded.

Each end portion 21 of the bus bar 20 and each electrode 12 are welded on both sides of the hole 23 (fused sites 31, 32). A sectional view taken along a dashed line V in FIG. 4 is illustrated in FIG. 5. For the sake of convenience of description, a region between the two holes 23 along the bus bar 20 will be referred to as an intermediate region of the bus bar 20, and regions outside of the intermediate region in a longitudinal direction of the bus bar 20 will be referred to as end regions. The bus bar 20 and the electrodes 12a (12b) are welded on both sides of the holes 23a (23b). The fused sites 31 belong to the intermediate region, and the fused sites 32 belong to the end regions. The end regions may be expressed as regions between the holes 23 and the bus bar ends. In FIG. 4, fused sites 31 and 32 are shown in gray. Note that the fused sites 31a and 31b will be collectively referred to as fused sites 31, and the fused sites 32a and 32b will be collectively referred to as fused sites 32.

In the manufacturing method according to the first embodiment, after welding the bus bar 20 and one electrode (e.g., the electrode 12a), when welding the bus bar 20 and the other electrode (e.g., the electrode 12b), the bus bar 20 and the electrode 12b are first welded at the fused site 31b, following which the bus bar 20 and the electrode 12b are welded at the fused site 32b. In other words, after welding the bus bar 20 and one electrode (e.g., the electrode 12a), the bus bar 20 and the other electrode (electrode 12b) are welded in the intermediate region (fused site 31b) between the two holes 23 of the bus bar 20, and subsequently the bus bar 20 and the other electrode (electrode 12b) are welded at the end region (fused site 32b) adjacent to the intermediate region of the bus bar 20. The bus bar 20 and the electrodes are welded by the bus bar 20 being irradiated by a laser beam for welding.

The aspects of the above welding sequence will be described with reference to FIG. 5. Assumption will be made regarding a case in which the bus bar 20 and the electrode 12a are welded, following which the bus bar 20 and the electrode 12b are welded in the end region (fused site 32b), and then the bus bar 20 and the electrode 12b are welded in the intermediate region (fused site 31b). When welding is performed at the fused site 31b, the bus bar 20 thermally expands due to the heat of welding. At this time, both sides of the fused site 31b (the electrode 12a side and the fused site 32b side) are constrained. The bus bar 20 cannot be freely deformed on both sides of the fused site 31b, and a high level of stress is generated. This high level stress may cause cracks in the bus bar 20, or remain as residual stress.

In the manufacturing method disclosed in the present specification, the bus bar 20 and one electrode 12 (e.g., the electrode 12a) are welded, following which the bus bar 20 and the other electrode 12 (e.g., electrode 12b) are welded in the intermediate region (fused site 31b), and subsequently the bus bar 20 and the other electrode (electrode 12b) are welded at the end region (fused site 32b) adjacent to the intermediate region.

When welding at the fused site 32b, one side of the fused site (the hole 23b side) is constrained, but the other side is not constrained. Accordingly, when the heat of welding is applied to the bus bar 20, there is room for the bus bar 20 to be deformed on the unconstrained side (the right end of the bus bar 20 in FIG. 5). Due to the bus bar 20 being deformed without being constrained, the stress occurring in the bus bar 20 in the vicinity of the fused site is reduced. Welding the bus bar 20 and the electrode 12b in the intermediate region and then welding the bus bar 20 and the electrode 12b in the end region enables the stress occurring in the bus bar 20 to be suppressed. As a result, occurrence of cracks in the bus bar 20 and increase in residual stress can be suppressed.

The same is true when the bus bar 20 and the electrode 12b are welded first, and then the bus bar 20 and the electrode 12a are welded. That is to say, the bus bar 20 and the electrode 12b are welded, following which the bus bar 20 and the electrode 12a are welded at the fused site 31a belonging to the intermediate region, and then the bus bar 20 and the electrode 12a are welded at the fused site 32a belonging to the end region adjacent to the intermediate region.

The holes 23 are located between the middle and the ends of the bus bar along the longitudinal direction of the bus bar 20. The region between the middle of the bus bar and the holes 23 may be referred to as an intermediate region, and the regions between the holes 23 and the ends of the bus bar may be referred to as end regions. The bus bar 20 and the electrodes 12 are welded on both sides of the holes 23. In the manufacturing method according to the first embodiment, the bus bar 20 and one electrode (electrode 12a) are welded, following which the bus bar 20 and the other electrode (electrode 12b) are welded by laser in the intermediate region, and then the bus bar 20 and the other electrode (electrode 12b) are welded by laser in the end region.

### Second Embodiment

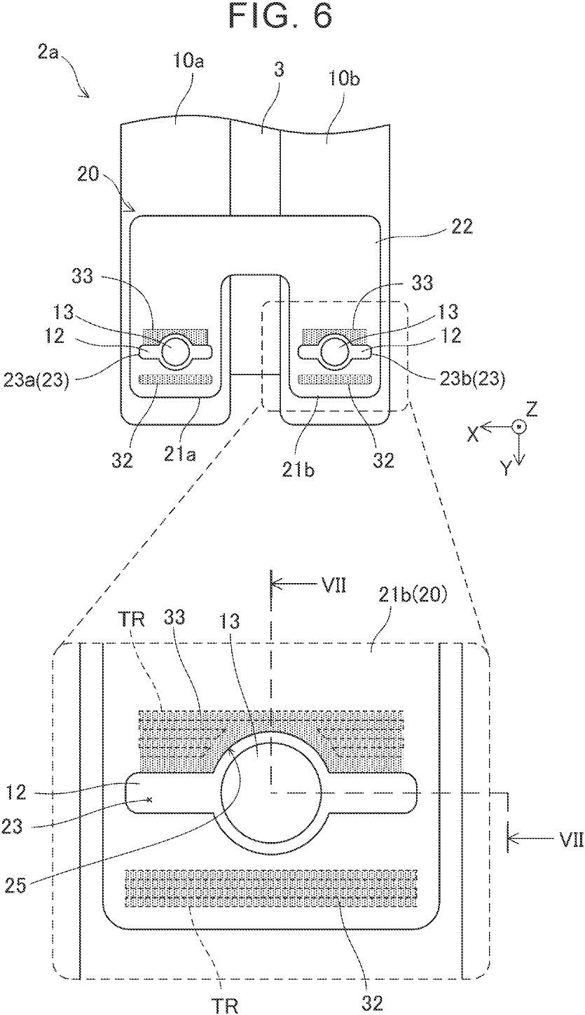

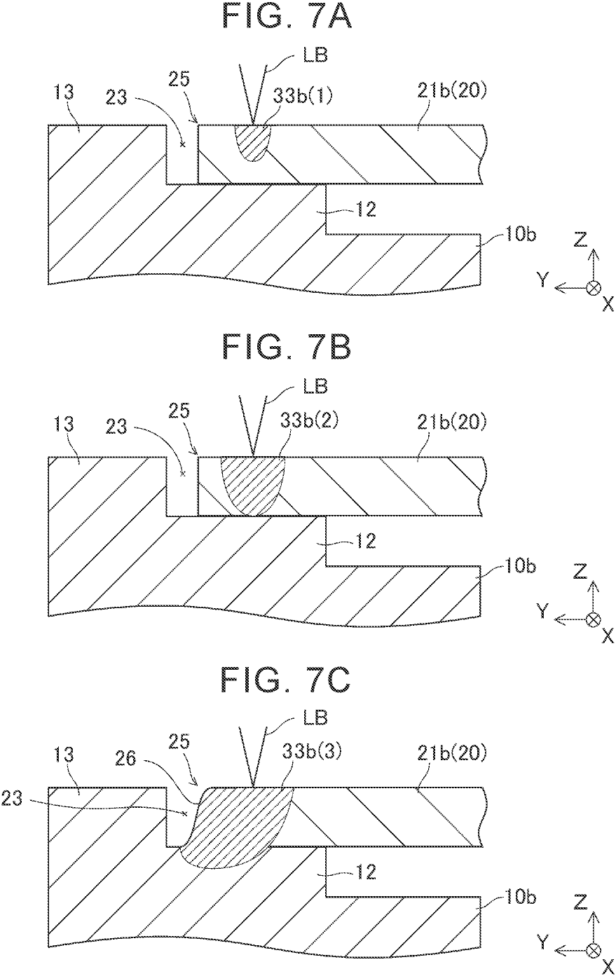

A manufacturing method according to a second embodiment will be described with reference to FIGS. 6 and 7A to 7C. FIG. 6 is a plan view of the vicinity of the bus bar 20. The lower part of FIG. 6 is an enlarged view of the area indicated by dashed lines. FIGS. 7A to 7C are sectional views taken along line VII-VII in FIG. 6. FIG. 7A is a diagram illustrating a state at the start of irradiation by laser LB for welding, and FIG. 7B is a diagram illustrating a state after a short amount of time has passed after starting irradiation by the laser LB. FIG. 7C is a diagram illustrating a state when the laser LB is stopped.

The shapes of the battery cells 10a and 10b and the bus bar 20 are the same as those in the first embodiment. The bus bar 20 has two holes 23 that are smaller than the electrodes 12. The bus bar 20 is disposed so that the holes 23 overlap the electrodes 12, respectively. In the manufacturing method of the second embodiment, the method of applying the laser at fused sites 33 is different from that in the first embodiment.

To facilitate understanding, in FIG. 6, the fused sites 32 and 33 are indicated by gray hatching. As described above, the “fused sites” are ranges in which metal is temporarily melted by the heat of welding (heat of the laser), and when cooled and resolidified, the bus bar and the terminal are joined. A dashed line TR in the lower figure of FIG. 6 represents a path of the laser for welding. That is to say, the fused site 33 reaches an edge 25 of the hole 23, but the bus bar 20 is irradiated by the laser for welding at a position away from the edge 25. In other words, the laser (dashed line TR) does not reach the edge 25 of the hole 23, but the fused site 33 reaches the edge 25 of the hole 23.

In the manufacturing method according to the second embodiment, the bus bar 20 is irradiated by the laser LB at a position away from the edge 25 of the hole 23, and the irradiation of the laser LB is stopped when the bus bar 20 melts up to the edge 25. As illustrated in FIG. 7A, for a while after starting irradiation by the laser LB, the fused site 33b(1) was small, only a front face of the bus bar 20 was melted, and the melting range did not reach a rear face of the bus bar 20. Here, the term rear face of the bus bar 20 means the face facing the electrode 12.

When irradiation by the laser LB is further continued, the fused site 33b(2) is enlarged. FIG. 7B illustrates a state in which the fused site 33b(2) has reached the rear face of the bus bar 20. When irradiation by the laser LB is further continued, the fused site 33b(2) reaches the edge 25 of the hole 23. At this time, the inner side face 26 of the hole 23 melts from the edge 25 of the front face side of the bus bar 20 to the edge of the rear face side. A surface of the electrode 12 beneath the bus bar 20 also melts. The rear face of the bus bar 20 and the surface of the electrode 12 melt, and the two are joined. When the laser LB is stopped in the state illustrated in FIG. 7C, the fused site 33b(3) spreads from the edge 25 of the front face side of the bus bar 20 to the edge of the rear face side. The state illustrated in FIG. 7C shows a structure (shape) of so-called fillet welding, which yields high welding strength.

Also, in the manufacturing method of the second embodiment, the irradiation point by the laser LB is away from the edge 25 of the hole 23. Accordingly, even when the irradiation point of the laser LB is slightly deviated, the laser LB does not directly strike the electrode 12. Thus, the amount of heat of welding transmitted to the battery cell 10 is suppressed, and damage of the battery cell 10 due to the heat of welding can be suppressed.

In the second embodiment, the fused site 32 does not reach the edge of the hole 23 in the end region. The welding range may be extended up to the edge 25 in the end region as well, in the same way as with the fused site 33. Note however, that the laser LB continues to irradiate a position away from the edge 25.

Points to be noted regarding the technology described in the embodiments will be described. The fused site 33 according to the second embodiment can be expressed as follows. For the sake of convenience of description, the two holes provided in the bus bar 20 will be referred to as a first hole 23a and a second hole 23b respectively. The bus bar 20 and the electrode 12 are welded on both sides of the first hole 23a. On the side closer to the second hole 23b, the bus bar 20 and the electrode 12 are welded up to the edge of the first hole 23a (fused site 33). On the side far from the second hole 23b, the fused site 32 is away from the edge of the first hole 23a.

The same is true regarding the vicinity of the second hole 23b. On the side closer to the first hole 23a, the bus bar 20 and the electrode 12 are welded up to the edge of the second hole 23b (fused site 33). On the side far from the first hole 23a, the fused site 32 is away from the edge of the second hole 23b. The fused site 33 belongs to the intermediate region according to the first embodiment, and the fused site 32 belongs to the end region according to the first embodiment.

Technology that combines the manufacturing method according to the first embodiment and the manufacturing method according to the second embodiment is also suitable. That is to say, after welding the bus bar 20 and one electrode (e.g., the electrode 12a), the bus bar 20 and the other electrode (e.g., electrode 12b) are welded in the intermediate region between the two holes 23 of the bus bar 20, and subsequently the bus bar 20 and the other electrode (electrode 12b) are welded at the end region adjacent to the intermediate region of the bus bar 20. In the welding of the intermediate region, the bus bar 20 is irradiated by the laser LB at a position away from the edge of the hole 23, and the irradiation of the laser LB is stopped when the bus bar 20 melts up to the edge 25. In the end region, the bus bar 20 and the electrode 12 are welded so that the fused site 32 does not reach the edge 25 of the hole 23.

While specific examples of the disclosure have been described in detail above, these are merely exemplary, and are not intended to limit the scope of the claims. The technology described in the claims includes various modifications and alterations of the specific example indicated above. The technical elements indicated in the present specification or in the drawings have technical utility alone or in various combinations, and are not limited to the combinations described in the claims as originally filed. Also, the technology indicated in the present specification or in the drawings may achieve a plurality of objects at the same time, and has technical utility by achieving one of such objects by itself.

What is claimed is:

1. A manufacturing method of a battery pack in which multiple battery cells are stacked, and electrodes of adjacent battery cells of the battery cells are connected by a bus bar, the bus bar having two holes that are smaller than the electrodes, and the bus bar being disposed such that the holes overlap the electrodes respectively, the manufacturing method comprising:
welding the bus bar and one of the electrodes;
then welding the bus bar and another one of the electrodes in an intermediate region between the two holes of the bus bar; and
subsequently welding the bus bar and the other one of the electrodes in an end region adjacent to the intermediate region of the bus bar.

2. The manufacturing method according to claim 1, wherein the bus bar is irradiated by laser at a position away from an edge of one of the holes, and irradiation by the laser is stopped when the bus bar melts up to the edge.

3. The manufacturing method according to claim 1, wherein, in welding of the intermediate region, the bus bar is irradiated by laser at a position away from an edge of one of the holes, and irradiation by the laser is stopped when the bus bar melts up to the edge.

4. A manufacturing method of a battery pack in which multiple battery cells are stacked, and electrodes of adjacent battery cells of the battery cells are connected by a bus bar, the bus bar having two holes that are smaller than the electrodes, and the bus bar being disposed such that the holes overlap the electrodes respectively, the manufacturing method comprising irradiating the bus bar by laser at a position away from an edge of one of the holes, and stopping irradiation by the laser when the bus bar melts up to the edge.
